(19) United States
(12) Patent Application Publication
(10) Pub. No.: US 2005/0059398 A1
(43) Pub. Date: Mar. 17, 2005

(54) Telecommunication method and system

(75) Inventors: Gaelle Jaupitre, Paris (FR); Herve Maillard, Igny (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/920,272

(22) Filed: Aug. 18, 2004

(30) Foreign Application Priority Data
Sep. 11, 2003 (EP) 03292228.8

(51) Int. Cl. H04Q 7/24

(52) U.S. Cl. 455/435.2

(57) ABSTRACT

The present invention relates to a telecommunication method for first and second wireless networks being coupled, the method comprising the steps of: registration of a mobile terminal with the first wireless network by means of a application layer identifier, registration of the mobile terminal with the second wireless network by means of a network layer identifier storing of the application layer identifier in conjunction with the network layer identifier for routing of a telecommunication link from a data source to the mobile terminal.

### BACKGROUND OF THE INVENTION

The invention is based on a priority application EP 03 292 228.8 which is hereby incorporated by reference.

The present invention relates to the field of telecommunication, and more particularly without limitation, to dual mode telecommunication methods and systems.

Wireless local area network (WLAN) is a promising technology that can be used as a complement technology to UMTS/GPRS at hot-spots to provide high bandwidth and low costs. However the efficient integration of WLAN and UMTS/GPRS is still an open question. Various approaches for WLAN/GPRS integration have been considered in “Mobility management for an integrated network platform”, By Kuladinithi, K.; Konsgen, A.; Aust, S.; Fikouras, N.; Gorg, C., Mobile and Wireless Communications Network, 2002. 4th International Workshop, Pages: 621-625; and “Experimentation of TCP schemes over GPRS & WLAN” By Leang Tzeh Yeu; Liew, J.; Seah, W. K. G., Mobile and Wireless Communications Network, 2002. 4th International Workshop, Pages: 234-238.

One open issue is the provisioning of packet switch based services over heterogeneous networks constituted of both WLAN and UMTS/GPRS.

### SUMMARY OF THE INVENTION

The present invention provides for a telecommunication method for first and second wireless networks which are coupled. Initial network registration of a mobile terminal with the first wireless network (i.e. the way a mobile terminal is initially recognized by the network) is performed based on an application layer identifier, such as a permanent identifier, in particular the MSISDN of the mobile terminal.

For exmple, the MSISDN of a particular user can have an assigned service description which specifies GPRS and WLAN services for this user. The MSISDN is allocated to the user as part of a subscription process.

Network registration—in other words “hooking” a mobile terminal to a network to be able to establish a communication link—of the mobile terminal with the second wireless terminal is performed by means of a network layer identifier which is assigned to the mobile terminal by the second network. For example the network layer identifier is a temporary identifier, such as a temporary IP address, in particular a WLAN IP address. Note that “application and network level” terms refer to OSI layered model.

Typically application layer identifier for registration with the first wireless network is stored on non-volatile storage within the mobile terminal, e.g. on the subscriber identity module (SIM) card. After the mobile terminal has obtained it's network level identifier from the second wireless network it sends it's network level identifier to the first wireless network for storage in a mapping table in conjunction with the application level identifier. This mapping table is used for routing of a telecommunication link from a data source to a mobile terminal.

When the mobile terminal moves outside the hot-spot coverage provided by the second wireless network it sends a corresponding message to the first wireless network such that the temporary identifier which is stored in the mapping table is invalidated. This way it is ensured that no attempt is made to route a telecommunication link to the mobile terminal through the second wireless network, which would fail in this instance. As the mobile terminal itself informs the first wireless network that it has left the hot-spot hand-off latency is drastically reduced.

In accordance with a further preferred embodiment of the invention the packet data gateway (PDG) is used for mapping of the application layer identifier to the network layer identifier. The packet data gateway is specified in 3GPP TS 23.234 “3GPP system to wireless local area network (WLAN) interworking”. In this instance the MSISDN of the mobile terminal is sent to the packet data gateway as part of the registration procedure. As the packet data gateway performs the assignment of a WLAN IP address to the mobile terminal it has knowledge of this address and thus performs the mapping of the MSISDN to the WLAN IP address.

In accordance with a further preferred embodiment of the invention an authorization authentication accounting (AAA) server is used to perform the mapping.

In accordance with a further preferred embodiment of the invention the instance which performs the binding of the two networks selects one of the networks to establish a communication link when both networks are available to provide such a communication link to the mobile terminal. This selection can be based on any criterion, such as load balancing or security level.

In accordance with a further preferred embodiment of the invention the unit performing the MSISDN/GPRS IP address mapping is reused to perform the MSISDN/WLAN IP address mapping in accordance with the present invention.

### BRIEF DESCRIPTION OF THE DRAWINGS

In the following preferred embodiments of the invention are described by way of example by making reference to the drawings in which:

FIG. 1 is a block diagram of a telecommunication system having coupled wireless networks,

FIG. 2 is illustrative of a flow chart of a registration method,

FIG. 3 is illustrative of a flow chart of a routing method.

### DETAILED DESCRIPTION

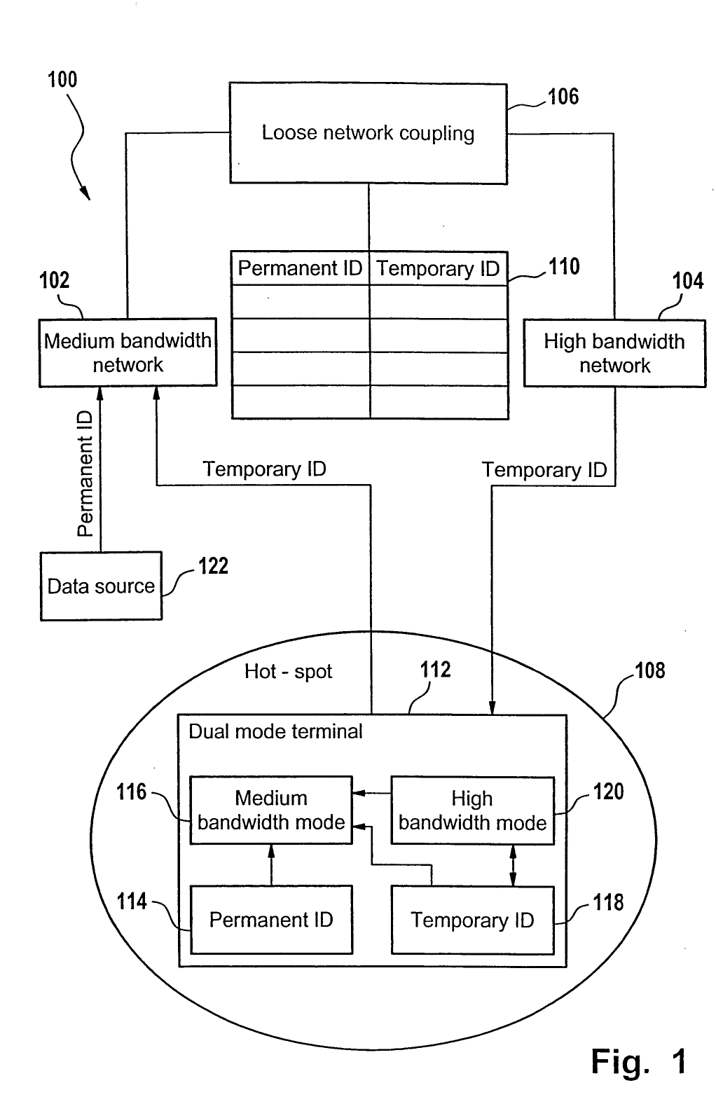

FIG. 1 shows telecommunication system 100 which has medium bandwidth wireless network 102 and high bandwidth wireless network 104. Medium bandwidth network 102 and high bandwidth 104 are coupled by means of network coupling component 106. Preferably network coupling component 106 implements a loose network coupling architecture.

Medium bandwidth network 102 provides global coverage whereas high bandwidth network 104 provides coverage for hot-spot 108. Hot-spot 108 is located within the coverage of medium bandwidth network 102.

Network coupling component 106 is connected to storage 110. Storage 110 stores a mapping table for mapping of permanent identifiers to temporary identifiers for the purposes of routing. This will be explained in more detail in the following.

Wireless dual mode terminal 112 is within the coverage of medium bandwidth network 102 and within hot-spot 108. Dual mode terminal 112 has non-volatile memory 114 for storage of a permanent identifier. For example non-volatile memory 114 is a SIM card which is inserted in a card reader of dual mode terminal 112. In this instance the MSISDN, i.e. the telephone number of dual mode terminal 112 can serve as the permanent identifier. Alternatively the IMSI can be used.

Dual mode terminal 112 has component 116 for operation in medium bandwidth mode. Component 116 is coupled to non-volatile memory 114 for reading of the permanent identifier from non-volatile memory 114.

Dual mode terminal 112 has memory 118 which can be a volatile or non-volatile memory for storage of a temporary identifier. Further dual mode terminal 112 has component 120 for operation in high bandwidth mode. Component 120 is coupled to memory 118 for writing and reading of the temporary identifier.

In operation dual mode terminal 112 registers with medium bandwidth network 102 on the basis of it's permanent identifier stored in non-volatile memory 114. The corresponding registration procedure is performed by component 116.

Further dual mode terminal 112 registers with high bandwidth network 104 when it is within hot-spot 108. During the registration procedure high bandwidth network 104 assigns a temporary identifier to dual mode terminal 112 which is stored by component 120 in memory 118. When the registration procedure of dual mode terminal 112 with high bandwidth network 104 is complete and the temporary identifier has been stored in memory 118 this is signalled from component 120 to component 116.

In response component 116 reads the temporary identifier from memory 118 and sends it to medium bandwidth network 102. Medium bandwidth network 102 sends the permanent identifier and the temporary identifier of dual mode terminal 112 to network coupling component 106 which stores the permanent identifier and the temporary identifier in the mapping table of storage 110.

When data source 122 wants to send data to dual mode terminal 112, such as multi media data, data source 122 provides the permanent identifier of dual mode terminal 112 to medium bandwidth network 102. Medium bandwidth network 102 forwards the permanent identifier to network coupling component 106 in order to check whether a valid temporary identifier is available in storage 102 for the permanent identifier provided by the data source 122.

In other words the mapping table of storage 110 is checked for the presence of the permanent identifier and a corresponding temporary identifier. If no temporary identifier is stored in storage 110 for the permanent identifier this is signalled from network coupling component 106 to medium bandwidth network 102 and a medium bandwidth communication link is established between data source 122 and dual mode terminal 112 via medium bandwidth network 102.

If network coupling component 106 retrieves a temporary identifier for the permanent identifier provided from data source 122 from the mapping table stored in storage 110, the temporary identifier is provided from network coupling component 106 to high bandwidth network 104 and a high bandwidth communication link is formed between high bandwidth network 104 and dual mode terminal 112 for transmission of data from data source 122 over network coupling component 106 and high bandwidth network 104 to dual mode terminal 112. In one application a so called MMS-message is transmitted this way from data source 122 to dual mode terminal 112.

When dual mode terminal 112 is moved outside hot-spot 108 this is recognised by component 120 as coverage from high bandwidth network 104 is lost. This is signalled from component 120 to component 116 which in response sends a message to medium bandwidth network 102 which indicates that dual mode terminal 112 is outside the coverage of high bandwidth network 104. This is possible due to the fact that medium bandwidth network 102 provides global coverage outside hot-spot 108.

In response to the message received from dual mode terminal 112 medium bandwidth network 102 sends a command to network coupling component 106 for the invalidation of the temporary identifier which is stored in storage 110.

It is important to note that dual mode terminal 112 and not high bandwidth network 104 initiates the invalidation of the temporary identifier stored in storage 110. This way it is ensured that the temporary identifier within storage 110 is invalidated with minimal latency. Hence when data source 122 wants to send data to dual mode terminal 112 no unnecessary attempt is made to form a communication link via high bandwidth network 104 as the move of dual mode terminal 112 outside hot-spot 108 is immediately reflected in storage 110.

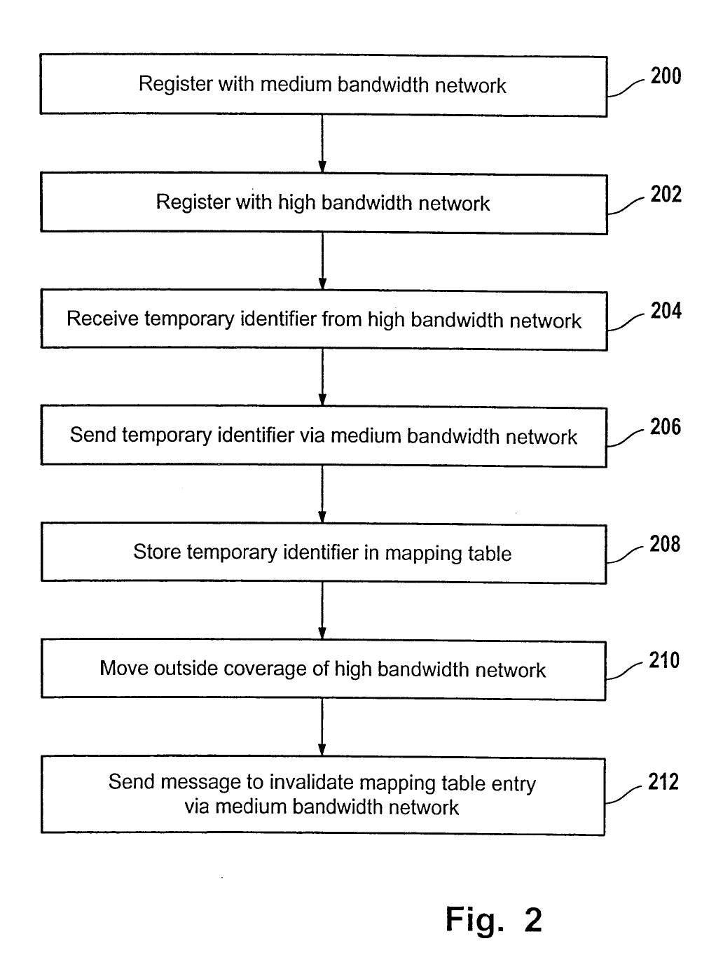

FIG. 2 shows a corresponding flow chart. In step 200 the wireless dual mode terminal registers with the medium bandwidth network. This is done by means of the permanent identifier of the dual mode terminal. In step 202 the dual mode terminal registers with the high bandwidth network when it is within the hot-spot coverage. As part of the registration procedure dual mode terminal receives a temporary identifier from the high bandwidth network in step 204.

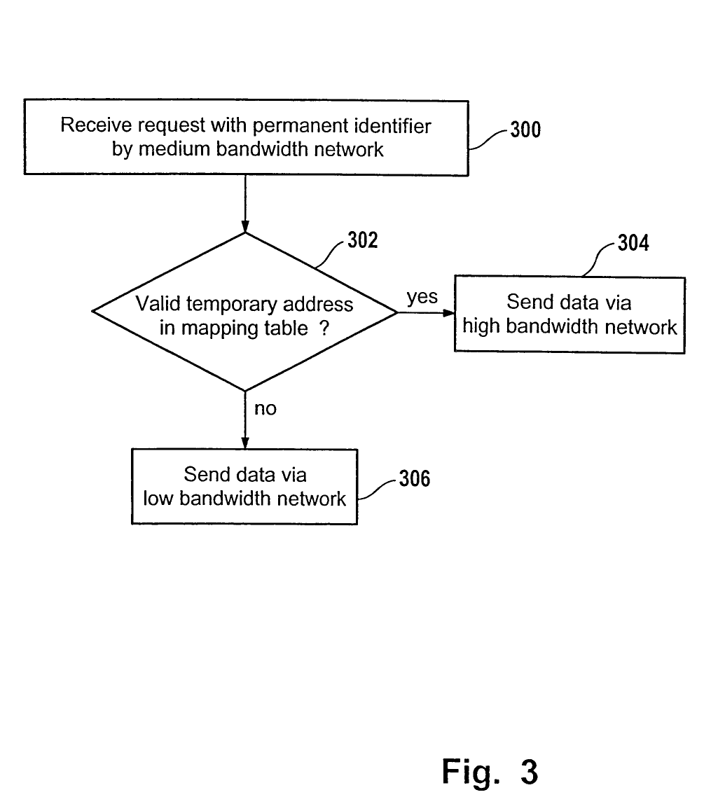

In step 206 the dual mode terminal sends the temporary identifier to the medium bandwidth network. The temporary identifier is stored in the mapping table for the purposes of routing of communication links to the dual mode terminal. The routing will be explained in more detail with respect to FIG. 3.

When the dual mode terminal moves outside the coverage of the high bandwidth network in step 210 a message is sent from the dual mode terminal to the medium bandwidth network in order to indicate that the dual mode terminal is outside the coverage of the high bandwidth network (step 212). In response the temporary identifier stored in the mapping table is invalidated.

FIG. 3 shows a corresponding routing method. In step 300 a request is received by the medium bandwidth network to establish a communication link to a mobile terminal. The mobile terminal is identified in the request by it's permanent identifier. In step 302 it is checked whether a valid temporary address is stored for the permanent identifier in the mapping table. If this is the case a communication link is formed via the high bandwidth network to the mobile terminal in order to send the data (step 304). If the contrary is the case a communication link is formed via the medium bandwidth network (step 306).

It is to be noted that the present invention is particularly suitable for integrationof GPRS medium bandwidth networks and WLAN high bandwidth networks. In this instance the MSISDN is used as the application layer identifier and the WLAN IP Address is used as the network layer identifier. However the present invention is not limited to any particular network standard but is broadly applicable to telecommunication systems having at least two wireless networks one of which providing global coverage.

In the case of GPRS/WLAN integration the temporary identifier can be transmitted from the mobile terminal to the GPRS medium bandwidth network by means of the IP protocol. Likewise the mobile terminal can inform the GPRS medium bandwidth network concerning its move outside the hot-spot coverage by means of an IP protocol message.

Alternatively the mobile terminal sends a packet data protocol (PDP) context activation request as a signalling message to the GPRS medium bandwidth network. The PDP context activation request contains the temporary IP address which has been assigned to the mobile terminal by the WLAN high bandwidth network. The PDP context activation address contains an access point name (APN) which is assigned to the mapping table.

When the SGSN receives the PDP context activation request it identifies the IP address of the mapping table by means of a domain name server (DNS) on the basis of the APN of the mapping table. The SGSN then forwards the temporary IP address of the mobile terminal as well as its MSISDN to the mapping table over IP protocol. Likewise the temporary IP address is invalidated in the mapping table by sending of a PDP context deactivation request from the mobile terminal to the GPRS medium bandwidth network.

List of Reference Numerals

100 telecommunication system
102 medium bandwidth network
104 high bandwidth network
106 network coupling component
108 hot-spot
110 Storage
112 dual mode terminal
114 non-volatile memory
116 Component
118 Memory
120 component
122 data source

1. A telecommunication method for first and second wireless networks being coupled, the method comprising the steps of:
registration of a mobile terminal with the first wireless network by means of a application layer identifier, the first wireless network providing coverage for a first region,
registration of the mobile terminal with the second wireless network by means of a network layer identifier, the second wireless network providing coverage for a second region,
storing of the application layer identifier in conjunction with the network layer identifier for routing of a telecommunication link from a data source to the mobile terminal.

2. The method of claim 1, further comprising the steps of:
providing of the application layer identifier from the data source to the first wireless network,
obtaining the network layer identifier on the basis of the application layer identifier for establishing the telecommunication link to the mobile terminal via the second network.

3. The method of claim 1, wherein the first network has a substantially lower bandwidth than the second network.

4. The method of claim 1, further comprising the steps of:
sending a message from the mobile terminal to the first network in order to indicate that the mobile terminal has been moved outside the second region,
invalidating the network layer identifier.

5. The method of claim 1, wherein a unit for performing a MSISDN/GPRS IP address mapping is reused to perform the MSISDN/WLAN IP address mapping in accordance with the present invention.

6. A wireless mobile terminal for usage with first and second wireless networks the wireless mobile terminal comprising:
means for registration with the first wireless network by means of a application layer identifier,
means for registration with the second wireless network by means of a network layer identifier,
means for sending of the network layer identifierto the first network.

7. The wireless mobile terminal of claim 6, further comprising means for sending a message to the first network in order to indicate that the wireless mobile terminal has been moved outside the coverage of the second network.

8. The wireless mobile terminal of claim 6, wherein the first network is a cellular-type network and the second network is a WLAN-type network.

9. A telecommunication system comprising:
a first wireless network providing coverage for a first region,
a second wireless network providing coverage for a second region,
the first wireless network having registration means for registration of a mobile terminal by means of a application layer identifier,
the second wireless network having registration means for registration of the mobile terminal by means of a network layer identifier, and
storage means for storing of a mapping table for the network layer identifier and the application layer identifier for the purpose of routing of a telecommunication link from a data source to the mobile terminal.

10. The telecommunication system of claim 9, wherein a packet data gateway receives from the mobile terminal an identifier known from the first network that enables to retrieve the application layer identifier.
